(19) United States
(12) Patent Application Publication
(10) Pub. No.: US 2024/0062940 A1
(43) Pub. Date: Feb. 22, 2024

(54) LEAD-FRAME STRUCTURE AND MAGNETIC CORE STRUCTURE COMBINED WITH LEAD-FRAME STRUCTURE

(71) Applicant: Mianyang Pulse Electronics Co., LTD., Mianyang City (CN)

(72) Inventors: Jia TANG, Mianyang City (CN); Mohammad SABOORI, San Diego, CA (US); Hamlet ABEDMAMOORE, San Diego, CA (US)

(21) Appl. No.: 17/983,891

(22) Filed: Nov. 9, 2022

(30) Foreign Application Priority Data
Aug. 17, 2022 (CN) 202210984503.1

(51) Int. Cl. H01F 17/04; H01F 27/29; H01F 27/30

(52) U.S. Cl. CPC H01F 17/043; H01F 27/292; H01F 27/306

(57) ABSTRACT

A lead-frame structure and a magnetic core structure combined with lead-frame structure are described. The lead-frame structure includes a frame, a first metal terminal assembly, and a second metal terminal assembly. The frame includes a first assembling portion and a second assembling portion spaced apart from each other. The first metal terminal assembly is formed on the first assembling portion and includes first terminals. The second metal terminal assembly is formed on the second assembling portion and includes second terminals. A top surface of each first terminal, a top surface of each second terminal, a top surface of the first assembling portion, and a top surface of the second assembling portion are coplanar. The magnetic core structure includes a body combined with the above-described lead-frame structure. The body provides convex beds to improve a positional accuracy of the first terminals and the second terminals.

### RELATED APPLICATIONS

This application claims priority to China Application Serial Number 202210984503.1, filed Aug. 17, 2022, which is herein incorporated by reference.

### BACKGROUND

### Field of Invention

The present disclosure relates to an auxiliary structure for positioning multiple metal terminals. More particularly, the present disclosure relates to a lead-frame structure and a magnetic core structure combined with the lead-frame structure.

### Description of Related Art

A first metal terminal assembly and a second metal terminal assembly are respectively mounted on two sides of a magnetic core structure through a first lead-frame structure and a second lead-frame structure. Since the first lead-frame structure and the second lead-frame structure are independent structures, the coplanarity and the positioning of the first metal terminal assembly and the second metal terminal assembly are worse, resulting in poor welding. The poor positioning may also lead to a short circuit.

### SUMMARY

Therefore, an objective of the present disclosure is to provide a lead-frame structure and a magnetic core structure combined with the lead-frame structure. The lead-frame structure improves the coplanarity and the positioning of metal terminals and reduces the welding defect rate. The magnetic core structure assists in positioning the metal terminals and prevents a short circuit.

According to the aforementioned objectives, the present disclosure provides a lead-frame structure, which includes a frame, a first metal terminal assembly, and a second metal terminal assembly. The frame includes a first assembling portion and a second assembling portion spaced apart from each other. The first metal terminal assembly is formed on the first assembling portion of the frame and has a plurality of first terminals. The second metal terminal assembly is formed on the second assembling portion of the frame and has a plurality of second terminals. A top surface of each of the first terminals, a top surface of each of the second terminals, a top surface of the first assembling portion, and a top surface of the second assembling portion are coplanar.

According to one embodiment of the present disclosure, each of the first terminals and the second terminals includes a top plate portion and a side plate portion. The top surface of the top plate portion is flat and is coplanar with the top surface of the first assembling portion. The side plate portion is formed on an end of the top plate portion and extends downwardly.

According to one embodiment of the present disclosure, one end of the top plate portion, which is opposite to the side plate portion, forms a chamfer portion.

According to one embodiment of the present disclosure, the frame further includes a middle portion, an opening, and two protecting feet. The middle portion is located between the first assembling portion and the second assembling portion. The opening is formed in the middle portion. The protecting feet are formed on two opposite inner side edges of the middle portion.

According to one embodiment of the present disclosure, each of the protecting feet includes a bending portion. The bending portion is located below the opening.

According to one embodiment of the present disclosure, a distance between a bottom end of each of the protecting feet and the top surface of the first assembling portion is larger than a distance between a bottom end of each of the first terminals and the second terminals and the top surface of the first assembling portion.

According to one embodiment of the present disclosure, each of the protecting feet includes an upper portion and a lower portion. The upper portion is connected to the middle portion. The lower portion is connected to the upper portion and is located below the opening, and a width dimension of the lower portion is tapered from top to bottom.

According to the aforementioned objectives, the present disclosure provides a magnetic core structure combined with the lead-frame structure, which has a body and the aforementioned lead-frame structure. The body has a center rod and two flange portions. The flange portions are mounted on two opposite ends of the center rod. Each of the flange portions includes a plurality of assembling surfaces and a plurality of convex beds. Each of the convex beds is located between adjacent two of the assembling surfaces. The lead-frame structure is combined with the body. The first terminals of the first metal terminal assembly are respectively mounted on the assembling surfaces of one of the flange portions. The second terminals of the second metal terminal assembly are respectively mounted on the assembling surfaces of the other one of the flange portions.

According to one embodiment of the present disclosure, a width of each of the convex beds is in a range from 0.28 mm to 0.38 mm, comprising endpoint valves.

According to one embodiment of the present disclosure, the convex beds are L-shaped.

It can be known from the aforementioned description that the first metal terminal assembly and the second metal terminal assembly are both formed on the same frame, which improves the positioning of the first terminals and the second terminals. The top surfaces of the first terminals, the top surfaces of the second terminals, the top surface of the first assembling portion, and the top surface of the second assembling portion are coplanar, which improves the coplanarity, thereby facilitating the subsequent assembling of the first terminals and the second terminals on the assembling surfaces of the flange portions, and also facilitating the subsequent welding operation of the copper wires.

When the first terminals and the second terminals are adhered to the assembling surfaces of the flange portions, the convex beds can assist the positioning of the first terminals and the second terminals to prevent a short circuit and can stop the overflowing of the adhesive.

### BRIEF DESCRIPTION OF THE DRAWINGS

In order to make the above and other objectives, features, advantages, and embodiments of the present disclosure more obvious, the accompanying drawings are described as follows:

FIG. 1 is a schematic three-dimensional diagram of a lead-frame structure in accordance with one embodiment of the present disclosure;

FIG. 2 is a schematic three-dimensional assembly diagram of terminals soldered to copper wires according to one embodiment of this present disclosure;

FIG. 3 is a schematic front view of the lead-frame structure not fully combined with a body of a magnetic core structure according to one embodiment of this present disclosure;

FIG. 4 is a schematic side view of the lead-frame structure not fully combined with the body of the magnetic core structure according to one embodiment of this present disclosure;

FIG. 5 is a schematic exploded view of combining the magnetic core structure with the lead-frame structure according to one embodiment of this present disclosure; and

FIG. 6 is a schematic three-dimensional assembly diagram of the terminals of the lead-frame structure adhered to assembling surfaces of the magnetic core structure according to one embodiment of this present disclosure.

### DETAILED DESCRIPTION

The spatial relationship between two elements described in the present disclosure applies not only to the orientation depicted in the drawings, but also to the orientations not represented by the drawings, such as the inverted orientation. In addition, the terms “first”, “second”, and the like, as used herein, are not intended to mean a sequence or order, and are merely used to distinguish elements or operations described in the same technical terms.

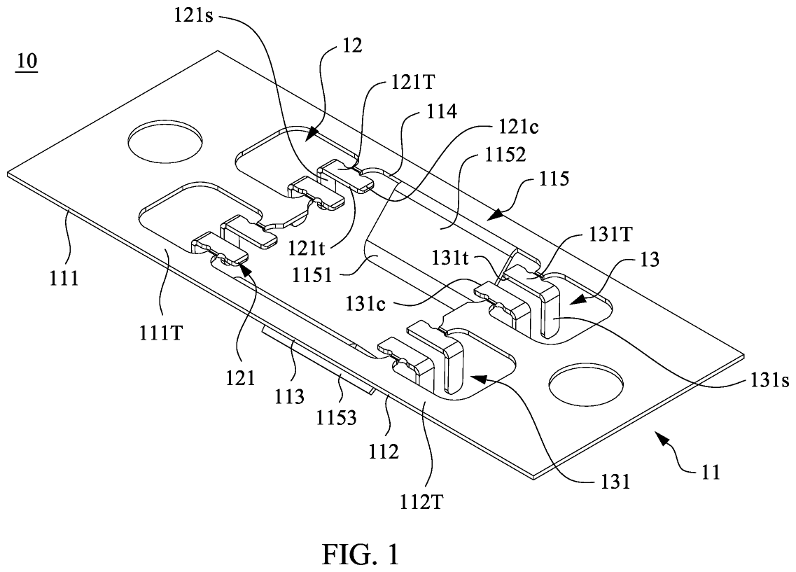

Referring to FIG. 1, FIG. 1 is a three-dimensional schematic diagram of a lead-frame structure 10 in accordance with one embodiment of the present disclosure. The lead-frame structure 10 includes a frame 11, a first metal terminal assembly 12, and a second metal terminal assembly 13. The frame 11 includes a first assembling portion 111 and a second assembling portion 112 spaced apart from each other. The first metal terminal assembly 12 is formed on the first assembling portion 111 of the frame 11 and includes first terminals 121. The second metal terminal assembly 13 is formed on the second assembling portion 112 of the frame 11 and includes second terminals 131. Top surfaces 121T of the first terminals 121, top surfaces 131T of the second terminals 131, a top surface 111T of the first assembling portion 111, and a top surface 112T of the second assembling portion 112 are coplanar. The coplanar configuration is beneficial to the subsequent welding operation, i.e. the coplanar configuration can prevent a height of a certain one of the terminals from being too high to cause over-welding which results in a breakage of a copper wire C, and can prevent a height of another one of the terminals is too low to cause insufficient welding which results in false wetting or non-wetting.

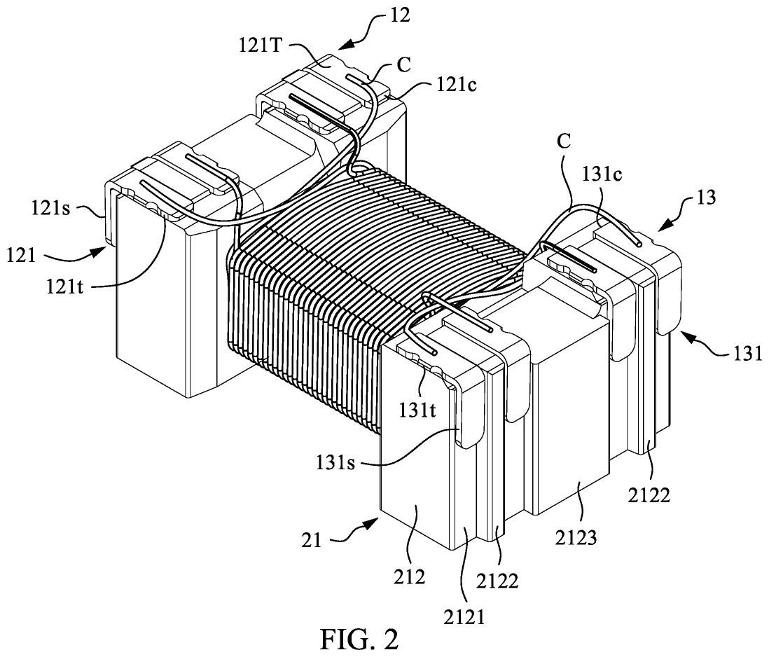

The first terminals 121 and the second terminals 131 are all L-shaped. Each first terminal 121 includes a top plate portion 121t and a side plate portion 121s, and each second terminal 131 includes a top plate portion 131t and a side plate portion 131s. Top surfaces of the top plate portions 121t and 131t are flat, i.e. the top plate portions 121t and 131t are not bent, such that the top surfaces of the top plate portions 121t and 131t are the top surfaces 121T of the first terminals 121 and the top surfaces 131T of the second terminals 131. Therefore, the top surfaces of the top plate portions 121t and 131t and the top surface 111T of the first assembling portion 111 are coplanar, and the top surfaces of the top plate portions 121t and 131t and the top surface 112T of the second assembling portion 112 are coplanar, too. The side plate portions 121s and 131s are respectively formed on ends of the top plate portions 121t and 131t and extend downwardly. One end of the top plate portion 121t and one end of the top plate portion 131t, which are opposite to the side plate portions 121s and 131s, form chamfer portions 121c and 131c. Referring to FIG. 2, FIG. 2 is a schematic three-dimensional assembly diagram of terminals soldered to copper wires C according to one embodiment of this present disclosure. The copper wires C are welded on the top surfaces of the top plate portions 121t and 131t and pass through the chamfer portions 121c and 131c. The chamfer portions 121c and 131c can prevent the edges of the top plate portions 121t and 131t from scratching the copper wires C.

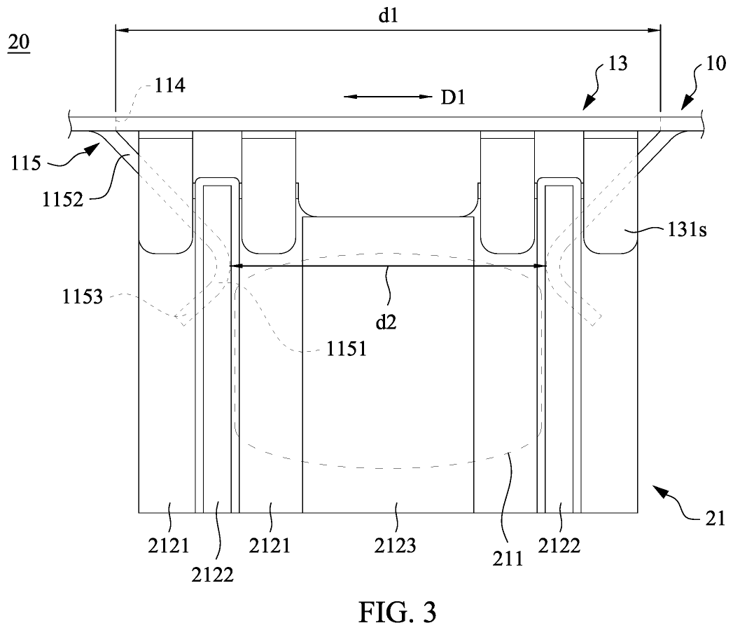

The frame 11 further includes a middle portion 113, an opening 114, and two protecting feet 115. The middle portion 113 is located between the first assembling portion 111 and the second assembling portion 112. The opening 114 is formed in the middle portion 113. Referring to FIG. 3, FIG. 3 is a schematic front view of the lead-frame structure 10 not fully combined with a body 21 of a magnetic core structure 20 according to one embodiment of this present disclosure. The protecting feet 115 are formed on two opposite inner side edges of the middle portion 113. A distance between the opposite inner edges of the middle portion 113 is a first distance d1, so a distance between the top edges of the protecting feet 115 is also the first distance d1. Each protecting foot 115 extends below the opening 114 and forms a bending portion 1151, such that the bending portion 1151 is located below the opening 114. A minimum distance between the bending portions 1151 of the protecting feet 115 is a second distance d2, and the second distance d2 is smaller than the first distance d1. In an assembly operation of combining the magnetic core structure 20 with the lead-frame structure 10, the second distance d2 is slightly larger than a width of a center rod 211 of the magnetic core structure 20 for assisting the positioning of the lead-frame structure 10 in a first direction D1.

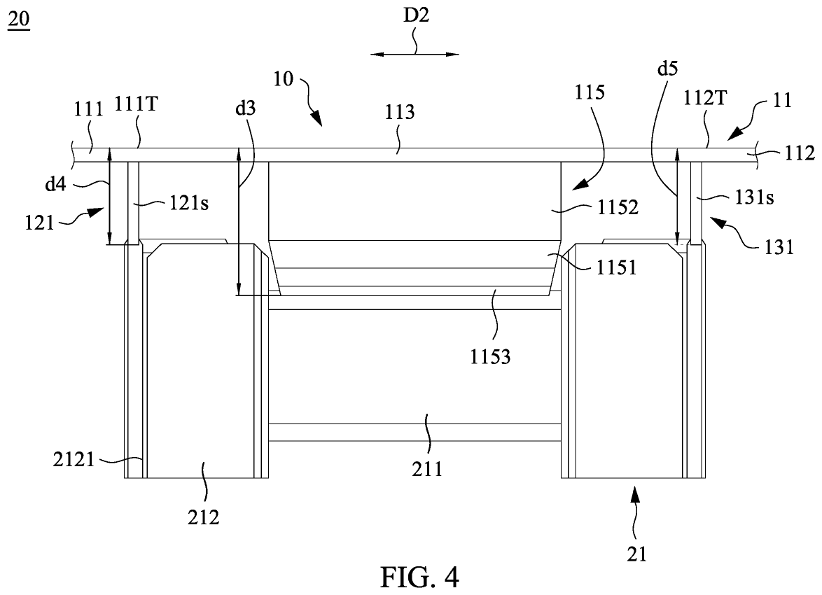

Referring to FIG. 4, FIG. 4 is a schematic side view of the lead-frame structure 10 not fully combined with the body 21 of the magnetic core structure 20 according to one embodiment of this present disclosure. A distance between a bottom end of each protecting foot 115 and the top surface 111T of the first assembling portion 111 is a third distance d3. A distance between a bottom end of each first terminal 121 and the top surface 111T of the first assembling portion 111 is a fourth distance d4. A distance between a bottom end of each second terminal 131 and the top surface 112T of the second assembling portion 112 is a fifth distance d5. Since the top surface 112T of the second assembling portion 112 and the top surface 111T of the first assembling portion 111 are coplanar, a distance between the bottom end of each second terminal 131 and the top surface 111T of the first assembling portion 111 is also the fifth distance d5. In one embodiment, the third distance d3 is larger than the fourth distance d4, and the third distance d3 is larger than the fifth distance d5. The lead-frame structure 10 may be used for a tape-on-reel packaging, and the protecting feet 115 can protect the first terminals 121 and the second terminals 131 from deformation during transportation. In one embodiment, the fourth distance d4 is equal to the fifth distance d5.

As shown in FIG. 4, each protecting foot 115 includes an upper portion 1152 and a lower portion 1153. The upper portion 1152 is connected to the middle portion 113. The lower portion 1153 is connected to the upper portion 1152 and is located below the opening 114, and a width dimension of the lower portion 1153 is tapered from top to bottom. In one embodiment, the bending portion 1151 is located at a junction of the upper portion 1152 and the lower portion 1153. In one embodiment, a width dimension of the bending portion 1151 is tapered from top to bottom. In the assembly operation of combining the magnetic core structure 20 with the lead-frame structure 10, the positioning of the lead-frame structure 10 in a second direction D2 may be assisted by the configuration of the lower portion 1153. In one embodiment, the second direction D2 is perpendicular to the first direction D1.

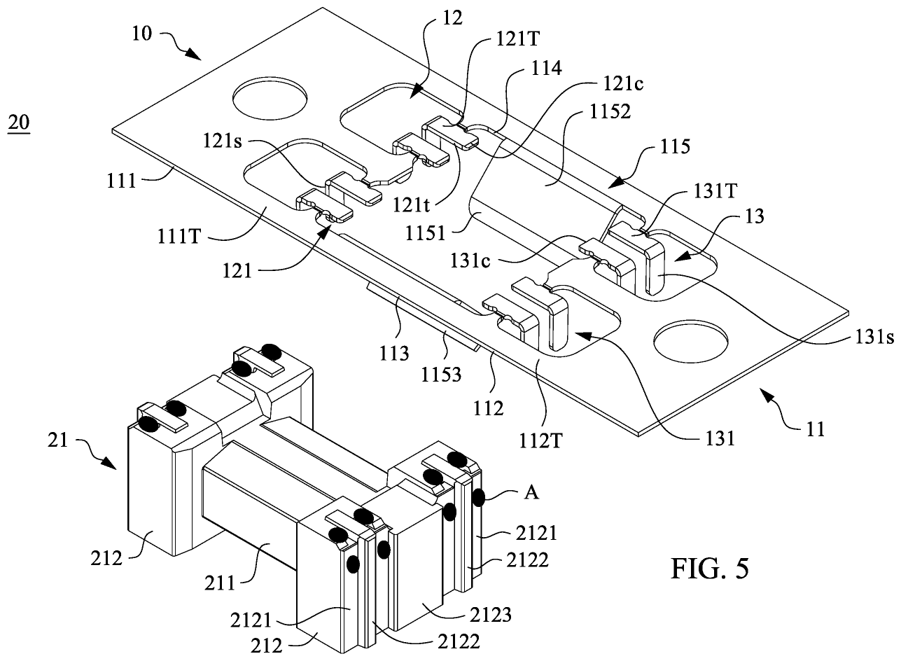

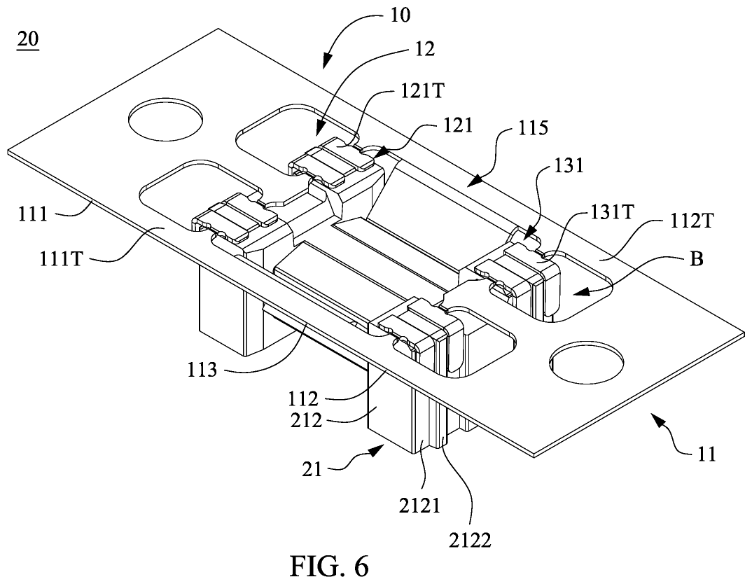

Referring to FIG. 5 and FIG. 6, FIG. 5 and FIG. 6 are respectively a schematic exploded view and a schematic perspective view of combining the magnetic core structure 20 with the lead-frame structure 10 according to one embodiment of this present disclosure. The magnetic core structure 20 combined with the lead-frame structure 10 includes a body 21 and the lead-frame structure 10. The body 21 includes a center rod 211 and two flange portions 212. The flange portions 212 are mounted on two opposite ends of the center rod 211. Each flange portion 212 has assembling surfaces 2121 and convex beds 2122, and each convex bed 2122 is located between the adjacent assembling surfaces 2121, such that the adjacent assembling surfaces 2121 are separated by the convex bed 2122. The lead-frame structure 10 is combined with the body 21. The first terminals 121 of the first metal terminal assembly 12 are mounted on the assembling surfaces 2121 of one of the two flange portions 212, and the second terminals 131 of the second metal terminal assembly 13 are mounted on the assembling surfaces 2121 of the other one of the two flange portions 212.

In one embodiment, the first metal terminal assembly 12 has four first terminals 121, and the second metal terminal assembly 13 has four second terminals 131. Each flange portion 212 further has a protrusion 2123 formed on a side surface of the flange portion 212, and has four assembling surfaces 2121 and two convex beds 2122. Two of the four assembling surfaces 2121 are located on one side of the protrusion 2123, and the other two of the four assembling surfaces 2121 are located on the other side of the protrusion 2123. The two convex beds 2122 are respectively located on the opposite sides of the protrusion 2123.

A width of each convex bed 2122 may be in a range from 0.28 mm to 0.38 mm, including endpoint values. In one embodiment, the width of each protrusion 2123 is larger than a width of each convex bed 2122. In each flange portion 212, a cross section of each convex bed 2122 is consistent from top to bottom, and a cross section of each assembling surface 2121 is consistent from top to bottom, that is, each assembling surface 2121 is flat and a width of each assembling surface 2121 is consistent from top to bottom, an outer surface of each convex bed 2122 is flat, and a cross-sectional profile of each convex bed 2122 is consistent from top to bottom. In one embodiment, the convex beds 2122 are L-shaped and extend from the side surfaces of the flange portions 212 to the top surfaces of the flange portions 212.

As shown in FIG. 2, FIG. 5, and FIG. 6, in an assembly operation, an adhesive A is attached to the flange portions 212 and the assembling surfaces 2121, and then the lead-frame structure 10 is combined with the body 21. In the lead-frame structure 10, the first terminals 121 and the second terminals 131 are located on the frame 11, and the first terminals 121 and the second terminals 131 are adhered to the corresponding assembling surfaces 2121 by the adhesive A. After the first terminals 121 and the second terminals 131 are fixed, the frame 11 of the lead-frame structure 10 is removed. Subsequently, a winding operation and a welding operation are carried out. The copper wires C are wound around the center rod 211 by a winding machine. The copper wires C are welded to the corresponding top plate portions 121t and 131t by a welding machine.

According to the aforementioned embodiments, one advantage of the present disclosure is that the first terminals and the second terminals of the present disclosure are all formed on the same frame, which can control the positions of the first terminals and the second terminals well, thereby improving the positioning of the first terminals and the second terminals. Therefore, in the subsequent welding operation, the improvement of the positioning facilitates to the normal welding of the copper wires to the first terminals and the second terminals.

Another advantage of the present disclosure is that the top surfaces of the first terminals, the top surfaces of the second terminals, the top surface of the first assembling portion, and the top surface of the second assembling portion are coplanar, such that the coplanarity of the first terminals and the second terminals is improved after they are adhered to and fixed on the assembling surfaces. Therefore, in the subsequent welding operation, the welding defect rate can be reduced, and the product yield can be enhanced. In addition, the top surfaces of the top plate portions are flat, which also can improve the coplanarity. Furthermore, the chamfer portions can prevent the copper wires from being scratched.

Still another advantage of the present disclosure is that in the magnetic core structure, the convex beds of the flange portions can assist the positioning of the first terminals and the second terminals. Therefore, when the first terminals and the second terminals are mounted on the assembling surfaces of the flange portions, a short circuit is avoided by the separation of the convex beds. The convex beds can also increase a positional accuracy of the first terminals and the second terminals. The convex beds can also provide a stop to prevent the adhesive from overflowing to other locations.

Yet another advantage of the present disclosure is that the protecting feet can assist the positioning of the lead-frame structure in the first direction and the second direction, such that the positioning of the first terminals and the second terminals is improved. In addition, the protecting feet can also protect the first terminals and the second terminals from be deformed in transportation.

Although the present disclosure has been described with the above embodiments, the above embodiments are not used to limit the present disclosure. Those skilled in the art can make various changes and modifications without departing from the spirit and scope of the present disclosure. Therefore, the protection scope of the present disclosure should be based on the defined by the scope of the appended patent application.

What is claimed is:

1. A lead-frame structure, comprising:
a frame comprising a first assembling portion and a second assembling portion spaced apart from each other;
a first metal terminal assembly formed on the first assembling portion of the frame and comprising a plurality of first terminals; and
a second metal terminal assembly formed on the second assembling portion of the frame and comprising a plurality of second terminals;
wherein a top surface of each of the first terminals, a top surface of each of the second terminals, a top surface of the first assembling portion, and a top surface of the second assembling portion are coplanar.

2. The lead-frame structure of claim 1, wherein each of the first terminals and the second terminals includes a top plate portion and a side plate portion, a top surface of the top plate portion is flat and is coplanar with the top surface of the first assembling portion, and the side plate portion is formed on an end of the top plate portion and extends downwardly.

3. The lead-frame structure of claim 2, wherein one end of the top plate portion, which is opposite to the side plate portion, forms a chamfer portion.

4. The lead-frame structure of claim 1, wherein the frame further comprises:
a middle portion located between the first assembling portion and the second assembling portion;
an opening formed in the middle portion; and
two protecting feet formed on two opposite inner side edges of the middle portion.

5. The lead-frame structure of claim 4, wherein each of the two protecting feet includes a bending portion, and the bending portion is located below the opening.

6. The lead-frame structure of claim 4, wherein a distance between a bottom end of each of the two protecting feet and the top surface of the first assembling portion is larger than a distance between a bottom end of each of the first terminals and the second terminals and the top surface of the first assembling portion.

7. The lead-frame structure of claim 4, wherein each of the two protecting feet includes an upper portion and a lower portion, the upper portion is connected to the middle portion, the lower portion is connected to the upper portion and is located below the opening, and a width dimension of the lower portion is tapered from top to bottom.

8. A magnetic core structure combined with a lead-frame structure, comprising:
a body comprising:
a center rod; and
two flange portions mounted on two opposite ends of the center rod, and each of the two flange portions comprising a plurality of assembling surfaces and a plurality of convex beds, each of the convex beds located between adjacent two of the assembling surfaces; and
the lead-frame structure of claim 1 combined with the body, the first terminals of the first metal terminal assembly respectively mounted on the assembling surfaces of one of the two flange portions, and the second terminals of the second metal terminal assembly respectively mounted on the assembling surfaces of the other one of the two flange portions.

9. The magnetic core structure combined with the lead-frame structure of claim 8, wherein a width of each of the convex beds is in a range from 0.28 mm to 0.38 mm, comprising endpoint values.

10. The magnetic core structure combined with the lead-frame structure of claim 8, wherein the convex beds are L-shaped.

11. The magnetic core structure combined with the lead-frame structure of claim 8, wherein each of the first terminals and the second terminals includes a top plate portion and a side plate portion, a top surface of the top plate portion is flat and is coplanar with the top surface of the first assembling portion, and the side plate portion is formed on an end of the top plate portion and extends downwardly.

12. The magnetic core structure combined with the lead-frame structure of claim 11, wherein one end of the top plate portion, which is opposite to the side plate portion, forms a chamfer portion.

13. The magnetic core structure combined with the lead-frame structure of claim 8, wherein the frame further comprises:
a middle portion located between the first assembling portion and the second assembling portion;
an opening formed in the middle portion; and
two protecting feet formed on two opposite inner side edges of the middle portion.

14. The magnetic core structure combined with the lead-frame structure of claim 13, wherein each of the two protecting feet includes a bending portion, and the bending portion is located below the opening.

15. The magnetic core structure combined with the lead-frame structure of claim 13, wherein a distance between a bottom end of each of the two protecting feet and the top surface of the first assembling portion is larger than a distance between a bottom end of each of the first terminals and the second terminals and the top surface of the first assembling portion.

16. The magnetic core structure combined with the lead-frame structure of claim 13, wherein each of the two protecting feet includes an upper portion and a lower portion, the upper portion is connected to the middle portion, the lower portion is connected to the upper portion and is located below the opening, and a width dimension of the lower portion is tapered from top to bottom.
